(19) United States
(12) Patent Application Publication
(10) Pub. No.: US 2003/0053656 A1
(43) Pub. Date: Mar. 20, 2003

(54) Digitally watermarking physical media

(76) Inventor: Kenneth L. Levy, Stevenson, WA (US)

Correspondence Address: DIGIMARC CORPORATION, 19801 SW 72ND AVENUE, SUITE 100, TUALATIN, OR, 97062, US

(21) Appl. No.: 10/233,327

(22) Filed: Aug. 29, 2002

Related U.S. Application Data
(63) Continuation-in-part of application No. 09/960,228, filed on Sep. 20, 2001.
Application No. 09/960,228 is a continuation-in-part of application No. 09/940,873, filed on Aug. 27, 2001.
(60) Provisional application No. 60/282,205, filed on Apr. 6, 2001.

(51) Int. Cl. G06K 9/00

(52) U.S. Cl. 382/100

(57) ABSTRACT

A digital watermark is embedded in an image or text. The embedded image or text is burned into a data side of a CD, CD-RW, SACD or DVD. The digital watermark is used as a counterfeit deterrent and as an identifier. Once extracted, the identifier can be used to link to related content via the internet.

### RELATED APPLICATION DATA

This application is a continuation-in-part of U.S. patent application Ser. No. 09/960,228, filed Sep. 20, 2001. The Ser. No. 09/960,228 application is a continuation-in-part of U.S. patent application Ser. No. 09/940,873, filed Aug. 27, 2001, and also claims the benefit of U.S. Provisional Application No. 60/282,205, filed Apr. 6, 2001. This application is also related to U.S. patent application Ser. No. 09/503,881, filed Feb. 14, 2000 and Ser. No. 09/924,402, filed Aug. 7, 2001.

### FIELD OF THE INVENTION

The present invention generally relates to digital watermarking and, more particularly, relates to digitally watermarking physical media such as CDs, DVDs, SACDs, mini-CDs, etc.

### BACKGROUND AND SUMMARY OF THE INVENTION

It's not as easy to spot a pirate as it used to be. The first time you laid eyes on Captain Hook you knew you were dealing with a pirate. Maybe it was the black flag. Maybe it was his motley crew. Now times have changed. Today pirates wear finely tailored suits. Or they lurk in a manufacturing facility in their garage. Yet a common thread binds today's pirates to their historic comrades—they seek to profit from other people's work and creativity. They remain common thieves.

Pirates (including counterfeiters and bootleggers) annually rob industry in the order of tens of billions. These losses are projected to double in the near future, particularly in today's digital world. Compact discs (CDs), digital versatile discs (DVDs) and other recording media are easy prey. They can be massively reproduced with over-the-counter computer equipment. Similarly, media packaging (e.g., art jackets or labels) is easily counterfeited using sophisticated, yet low-cost printers.

The consumer bares the brunt of counterfeiting and piracy. Many consumers purchase sub-par goods thinking that they are genuine. Consumers who purchase counterfeit DVDs or CDs can end up with low fidelity products or blank tracks.

A solution is needed to effectively combat piracy.

Digital watermarking provides a solution. Digital watermarking technology, a form of steganography, encompasses a great variety of techniques by which plural bits of digital data are hidden in some other object, preferably without leaving human-apparent evidence of alteration.

Digital watermarking may be used to modify media content to embed a machine-readable code into the media content. The media may be modified such that the embedded code is imperceptible or nearly imperceptible to the user, yet may be detected through an automated detection process.

Most commonly, digital watermarking is applied to media signals such as images, audio, and video signals. However, it may also be applied to other types of media, including documents (e.g., through line, word or character shifting, texturing, graphics, or backgrounds, etc.), software, multi-dimensional graphics models, and surfaces of objects.

There are many processes by which media can be processed to encode a digital watermark. Some techniques employ very subtle printing, e.g., of fine lines or dots, which has the effect of slightly tinting the media (e.g., a white media can be given a lightish-green cast). To the human observer the tinting appears uniform. Computer analyses of scan data from the media, however, reveals slight localized changes, permitting a multi-bit watermark payload to be discerned. Such printing can be by ink jet, dry offset, wet offset, xerography, halftone, etc. Other techniques vary the luminance, color qualities, or gain values in a signal to embed a message signal. The literature is full of digital watermarking techniques.

The encoding of a label (or non-data CD side) can encompass artwork or printing on the label, the label's background, a laminate layer applied to the label, surface texture, etc. If a photograph, graphic or image is present, it too can be encoded.

Digital watermarking systems typically have two primary components: an embedding component that embeds the watermark in the media content, and a reading component that detects and reads the embedded watermark. The embedding component embeds a watermark pattern by altering data samples of the media content. The reading component analyzes content to detect whether a watermark pattern is present. In applications where the watermark encodes information, the reading component extracts this information from the detected watermark. Previously mentioned U.S. patent application Ser. No. 09/503,881, filed Feb. 14, 2000, discloses various encoding and decoding techniques. U.S. Pat. Nos. 5,862,260 and 6,122,403 disclose still others. Artisans know many other watermarking techniques.

One form of digital watermark is a so-called “fragile” watermark. A fragile watermark is designed to be lost, or to degrade predictably, when the data set into which it is embedded is processed in some manner, such as signal processing, compression scanning/printing, etc. A watermark may be made fragile in numerous ways. One form of fragility relies on low watermark amplitude. That is, the strength of the watermark is only marginally above the minimum needed for detection. If any significant fraction of the signal is lost, as typically occurs in photocopying operations, the watermark becomes unreadable. Another form of fragility relies on the watermark's frequency spectrum. High frequencies are typically attenuated in the various sampling operations associated with digital scanning and printing. Even a high amplitude watermark signal can be significantly impaired, and rendered unreadable, by such photocopying operations.

Commonly assigned U.S. patent application Ser. No. 10/118,468, filed Apr. 5, 2002, discloses methods and systems to protect media such as VHS tapes, CDs, DVDs, etc. Media packaging or labels can be embedded with a digital watermark. The digital watermark is used as an identifier to facilitate asset management. Or the watermark can be used to control or regulate access to the media content. In one embodiment, a user shows the packaging or label side of the CD to a digital camera to link to the internet. In another embodiment, the digital watermark is used to verify authenticity of the CD.

Commonly assigned U.S. patent application Ser. No. 09/924,402 discloses an inspector network, which allows an inspector to efficiently detect counterfeited goods via a digital watermark identifier.

There is room in the art for additional counterfeit-deterring methods and techniques. Consider pirates who counterfeit product packaging (including labels) and then apply them to illegal media copies. In some cases a pirate can successfully counterfeit various types of digitally watermarked packaging.

An object of the present invention is to provide a digital watermark that offers additional anti-counterfeiting protection. In one embodiment, an inventive digital watermark includes visible effects of a digital optical storage media. Digital optical storage media includes CDs, DVDs (audio and video), Super Audio CDs (“SACDs”), laser discs, mini-discs, and all similar technology. Images, video, audio and/or data (e.g., software, text, etc.) can be stored on such optical storage media. For simplicity such media is referred to as a CD. In another embodiment, a digital watermark is imperceptibly embedded on a data side of a CD through varying a plurality of data pit placements.

An advantage of the present invention is that such a digital watermark is inherently difficult to copy by common recording CD devices and illegitimate production masters used in the mass production of counterfeited CDs. In one embodiment, the inventive digital watermark helps content owners find illegal CD counterfeits, either at the distributor, retailer or user location. In another embodiment, the inventive digital watermark allows an authentic watermarked CD to link via a network to additional content via the watermark—a distinct consumer advantage over counterfeited media. This method is cost effective since the process adds little or no production costs to individual CDs, and only minimal cost to the process of creating the original CD master. Once the master is created, each replica CD includes the watermark.

The foregoing and other features and advantages of the present invention will be more readily apparent from the following detailed description, which proceeds with reference to the accompanying drawings.

### BRIEF DESCRIPTION OF THE DRAWINGS

FIG. 1 is a block diagram showing a visual design watermarking method.

FIG. 2 is a diagram showing pit-deviations in a CD track segment according to one embodiment of the present invention.

FIG. 3 is a diagram showing the image capture of a CD according to a first embodiment of the present invention, and

FIG. 4 is a diagram showing the image capture of a CD according to a second embodiment of the present invention.

FIG. 5 is a diagram showing a network that is navigable with a CD identifier.

FIG. 6 illustrates embedding a signal in an image or text that is to be burned to a data side of a CD.

### DETAILED DESCRIPTION

One aspect of the present invention creates an imperceptible digital watermark on a CD surface through “pit” manipulation (or placement). Preferably, the digital watermark is arranged on the signal (or data) side of a CD. A pit is a small indentation (or other structure) in a CD surface that is used to convey data. Pits can be visually discernable. According to a first embodiment of the present invention, an imperceptible digital watermark is embedded in a visually perceptible CD pit pattern—much like watermarking a 2-dimensional image.

Pit alignment (or placement) has been used to create “visible” watermarks as demonstrated by Super Audio CDs (“SACDs”). In a first embodiment, my inventive imperceptible watermark is embedded within a CD's visible watermark or design. To simplify the terminology used herein a SACD-like “visible watermark” will be referred to hereafter as a “visual design” (or “pit-pattern”). As will be appreciated, SACD is a high-density disc format that uses a proprietary audio system developed by Philips and Sony. Like the DVD, SACD has high capacity used to achieve a high-quality, multi-channel surround sound. SACDs can be manufactured to include slight variations in their data encoding (or bit placement) to create a visible design effect on the data (or signal) side of an SACD. This visual design is physically placed onto the surface of SACD discs during the replication process using Pit Signal Processing (PSP) technology.

The SACD format provides additional security measures including SACD's own “invisible” watermark, which is stored separately in the data on the disc to prevent reading by non-compliant devices such as DVD-ROM drives. This invisible watermark is encoded (or stored) separately in a Direct Stream Digital (DSD) bit stream. In other words, the SACD invisible watermark resides in the data, not in the visible design or pit-pattern. The SACD invisible watermark can be analyzed through a 1-demensional collection of data bits, which are analyzed collectively.

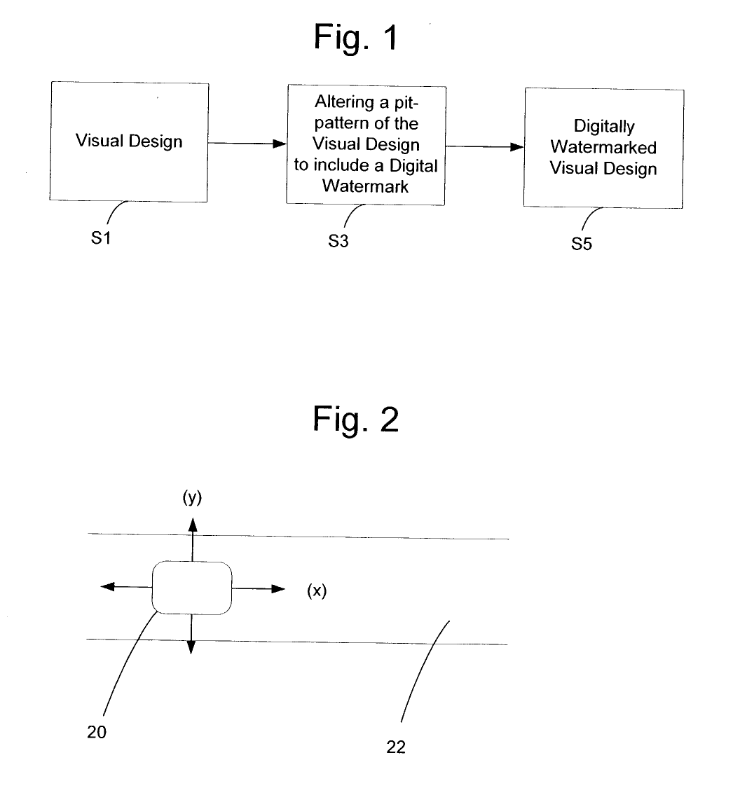

In the first embodiment, my inventive digital watermark is embedded in a visual design on a CD. Preferably, my watermark signal (e.g., a pseudo-random noise (PN) sequence) is implemented by slight adjustments to the pit-pattern of the visual design. Since digital watermarks use deviations that are not readily visible to the human eye, but are discernable to watermark detection software, the watermark embedding process preferably does not cause data-read errors in the CD. Such slight adjustments to pit locations are imperceptible or nearly imperceptible in comparison to the visual design. As an example embedding process, with reference to FIG. 1, a visual design is created (S1). The pit-pattern of the visual design is varied so as to embed a digital watermark signal therein (S3). A digitally watermarked visual design results (S5). This watermarked visual design can then be transferred to a CD master to enable production of the digitally watermarked CDs. In other embodiments, a digital watermark and visual design are concurrently determined. In still other embodiments, a watermark signal is used as the visual design.

Some CD tracking techniques include rings running parallel with the pits. These parallel ring tracks provide more latitude in moving a pit (20) in a track (22) circumference (x direction) as opposed to up and down, e.g., toward the edge or center of a CD (y direction). (See FIG. 2, which show a CD track segment including a pit.). In this case, moving a pit location slightly counter-clockwise could to represent a digital 1. Or moving a pit location slightly clockwise could represent a digital 0, or visa-versa. Of course other techniques can be used to similarly adjust pit-locations to embed a digital watermark, such as offsetting a pit location, elongating (or shortening) a pit indentation, pseudo-randomly deviating pit-locations, etc.

A pirated copy of a digitally watermarked CD will not include the digital watermark since the pirated copy will not readily include the pit-pattern. Common CD recording devices (e.g., CD-Rom burners) copy only 1's and 0's—not the visual design or embedded watermark formed through data pit placement. It is extremely difficult to counterfeit a CD master so as to include a likelihood of breaking the original's watermark encoding and/or encryption techniques as carried by a pit-pattern. This is particularly true since content owners or CD producers can secretly maintain a watermark protocol, e.g., including a PN sequence. In addition, CD production equipment, capable of creating visual designs, is far more expensive than a standard CD-Rom burner—creating a significant barrier to entry for the common pirate.

Identical pit deviations can be included in every CD copy made on mass-production equipment. In this case, each watermark includes the same identifier. Alternatively, the pit deviations may be changed for each CD to create a unique CD serialization. CD serialization allows each CD to be traced. In one embodiment, a watermark payload per each individual CD includes a common ID (e.g., to identify media title, manufacture, batch run number, date produced, copyright owner, etc.) and/or serialization payload field (or individual CD identifier). The common ID is used for linking, as described below, and the count is used for forensic tracking of each CD.

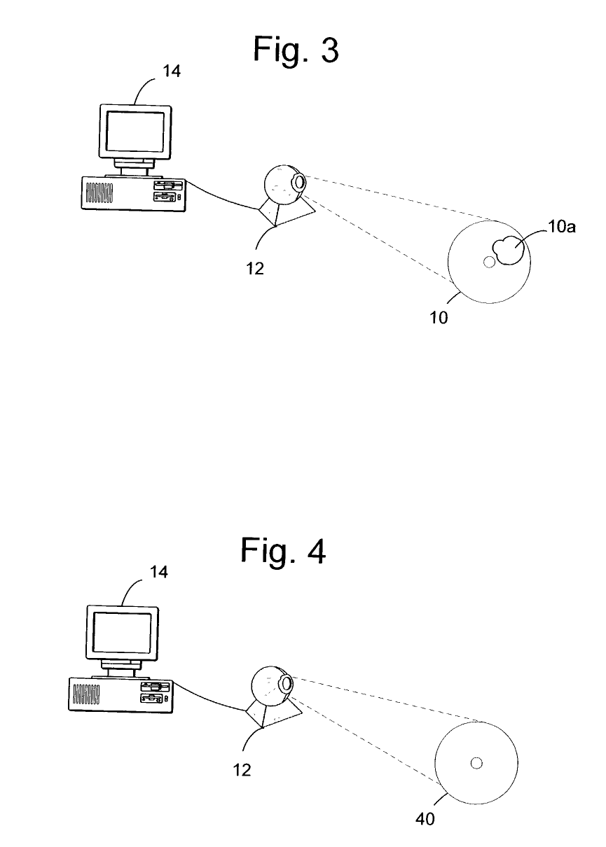

With reference to FIG. 3, a data side of CD 10 is presented to an input device 12, such as a digital camera, web camera, optical sensor, etc. CD 10 preferably includes a visual design 10a located on a data side of CD 10. Visual design 10a preferably includes a digital watermark embedded therein. (Of course, a non-data CD side may include text, graphics, artworks, images, etc., which may be embedded with a conventional digital watermark. This conventional digital watermark can be compared to the watermark embedded in the visual design, or can be used as a separate or additional identifier or security check.). Input device 12 captures an image of the digitally watermarked visual design 10a. This captured image is communicated to computer 14. Of course, input device 12 can be tethered to computer 14 (as shown) or can otherwise interface with computer 14. Alternatively, input device 12 wirelessly communicates with computer 14, e.g., via Bluetooth or other wireless protocol. Computer 14 preferably includes watermark detection and decoding software instructions stored in memory to be executed on computer 14's processor and/or processing circuitry. Computer 14 executes these software instructions to analyze the captured CD image. The embedded watermark is detected from such. In some embodiments, the digital watermark includes a payload or message. Computer 14 preferably extracts the watermark payload from the captured image if present. Computer 14 need not be desktop device as illustrated in FIG. 3. To the contrary computer, 14 can include a handheld device, a laptop, a distributed server system, etc.

My inventive digital watermark need not be embedded in a CD's visual design. Indeed, my inventive digital watermark can be embedded in a CD that does not include a visual design. In a second embodiment, location adjustments (or placements) are made to a set of pits on a data side of a CD. As with the first embodiment, these pit placements can be manipulated in a track circumference direction, or by offsetting a pit location, elongating (or shortening) a pit indentation, pseudo-randomly deviating pit-locations, etc. Alternatively, reflective characteristics of a pit can be altered to convey a digital watermark component. Preferably, the pit location adjustments are imperceptible, or nearly imperceptible, to human observation, yet are detectable through watermark detection analysis.

With reference to FIG. 4, a CD 40 includes a digital watermark embedded through imperceptible (or nearly imperceptible) pit placements on its data side. CD 40 need not include a visual design. CD 40 can be presented to input device 12. Input device 12 captures an image of CD's data side, which includes the embedded digital watermark. This captured image is communicated to computer 14. Computer 14 executes watermark detection and decoding software instructions to analyze the captured CD image. The embedded watermark is detected from such. (Like with the first embodiment, a non-data CD 40 side may optionally include text, graphics, artworks, images, etc., which may be embedded with a conventional digital watermark. This conventional digital watermark can be compared to the watermark embedded through pit placement, or can be used as a separate or additional identifier or security check.).

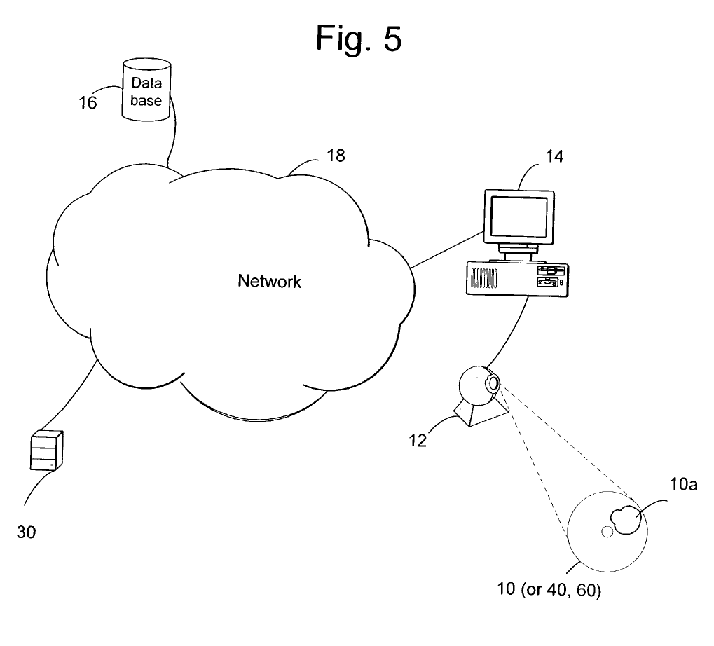

In an alternative embodiment, with reference to FIG. 5, computer 14 communicates an extracted watermark ID to a database (and router) 16. The watermark ID can be extracted from an image of (or sensor data from) either CD 10 or 40 (or CD 60, discussed below). Database 16 is preferably accessible via a network 18 (e.g., internet, intranet, extranet, wireless network, LAN, WAN, etc.). Alternatively, database 16 is local with respect to computer 14. Database 16 communicates information (e.g., a URL, web address, e-mail address, IP address, etc.) to computer 14 to redirect computer 14 to a web site 30. Assignee's U.S. patent application Ser. No. 09/571,422, filed May 15, 2000, discloses related linking methods and apparatus.

Web site 30 preferably includes accessible content related to CD 10, 40 or 60, such as information about the music, artist, song, movie, actors, content, data, software, content owners, images, etc., contained thereon. Web site 30 also may be a private site, which is only assessable to users via the watermarked CD. Copying or bookmarking the website URL (or link) preferably will not enable user access to the private web site since the link is enabled by a central routing system (e.g., router 16) that receives the watermark ID from a user computer 14. IP address checking and time stamping are some of the ways to help secure a private web site. Assignee's U.S. patent applications Ser. No. 09/853,835, filed May 10, 2001, and Ser. No. 09/864,084, filed May 22, 2001, disclose still other techniques for securing a private web site. Such website security techniques may be suitably interchanged with this aspect of the present invention.

A digital watermark can also be used to verify that CD 10, 40 or 60 is authentic (e.g., is not a pirated copy). Inspection agents in retail or distribution channels using the linking techniques described above and/or the techniques described in Assignee's U.S. patent application Ser. No. 09/924,402 can verify the watermark. If an inspection agent finds a CD without a pit-placement watermark, e.g., when that CD should include a pit-placement watermark, the agent has a clue to determine whether the CD is pirated. In another example, if a CD label provides instructions to hold the CD's data side to a web camera to enable the above-described web linking, and nothing happens, then the CD is probably a pirated copy. The CD label or other packaging can include further instructions in the event of a linking-failure (e.g., upon reading a pirated copy). The instructions can include how to contact the CD or DVD owner or distributor with information that can help trace the origins of the illegal copy.

Similarly, a consumer can verify a CD's (10, 40 or 60) authenticity by testing the linking capabilities of the CD's pit-placement watermark, e.g., prior to purchasing the CD via a web-enabled store kiosk or hand-held device. Or the consumer can verify authenticity at home after the purchase. If the consumer finds copied CD/DVDs, they can be provided with instructions and incentives to contact the content owner, helping reduce piracy. Of course, this concept is equally applicable to audio, video and data (e.g., such as software) CDs.

Serialized CDs, discussed above, can be tracked to learn who has purchased and re-purchased the CDs. Or serialization can be used to trace the origin of an illegal copy.

In an alternative embodiment, visible design 10a (FIG. 3) itself is used as an identifier instead of an identifier carried by a digital watermark. Pattern recognition software is used to detect the visual design 10a. The pattern of the visual design 10a is associated with an identifier, which is used as a substitute for the watermark identifier discussed herein. In still another embodiment, the visual design 10a is mathematically analyzed, e.g., via a hash or fingerprinting algorithm. The resulting hash or fingerprint value is used as an identifier. A hash or fingerprint database can be consulted to determine an action or to obtain additional information associated with the identifier. Hence, the visual design or pit-pattern itself can serve as (or be used to derive) an identifier.

In one embodiment, a digital pit-placement watermark is fragile—meaning that it is lost or sufficient degraded when copied, e.g., copied by a CD burner since CD burners will not reproduce the precise pit variations (or locations). The same digital pit-placement watermark also has some robust features, e.g., it is durable and persistent since it is embedded through the placement of physical CD pits. Preferably, a pit-placement watermark creates a 2D imperceptible (or nearly imperceptible) digital watermark that can be captured by a conventional digital camera. A captured image of the pit-placement digital watermark can be analyzed by a watermark detection module (e.g., software or hardware/software combinations). The watermark detection module may optionally carry identifying information that can be used to enhance a CD and to connect a user to related information.

Up to this point in the disclosure I have primarily focused on images and watermark embedding via pit placements. My inventive techniques extend to other embedding techniques as well. For example, Yamaha Electronics Corporation has recently introduced its CRW-F1 CD burner, which allows a user to burn a visible image or visible text directly onto a data side of a recordable or re-writable CD. The CRW-F1 CD burner incorporates a technology known as DiscT@2 Laser Labeling System, which helps with the image or text burning. Generally, an image or text is burned into the data side of the disc by arranging (e.g., burning) data (ones and zeros) variously throughout the data side. One example of this technology allows song titles to be textually conveyed on a data side of the CD track (e.g., preferably on an outside track since standards, such as Yellow Book standard, enable this track to be ignored by CD players). The labeling technology arranges ones and zeros (e.g., variously arranged data pits vs. lands, or variously effects the reflectivity of a light sensitive CD material) to convey the text or image. (Of course we recognize that data pits often represent a transition between zeros and ones and not a zero or one directly.).

An improvement is to embed a digital watermark or other steganographic message in an image or text that is burned into the data side of a disc. The watermark can include a serial number, identifier or other message payload. The identifier (or payload) can uniquely identify the CD, content stored on the CD, a batch of CDs, an artist, a music studio, etc., etc. The identifier can also be used as a link to related information.

A digital watermark can be embedded by modifying the pit placement of the text, e.g., so that a copy is unable to replicate the precise pit locations—effectively loosing the watermark, as described above.

A watermark also can be embedded by modifying the text, such that the 0's 1's are modified in this text track. This watermark can exist as a background watermark, or through subtle variation to the text itself. Alternatively, a watermark can be based upon text watermarking methods, where text features are modified to carry a watermark signal. We note however, that when the text is modified, such that the 0's and 1's are changed, this watermark becomes more easily copy-able because it exists in the data.

The data track can carry images as well as text. In this case, the watermark can be hard to copy and based upon pit placement or be imperceptible embedded by toggling or changing select 0's and 1's of the image.

Alternatively, a visible data-carrying logo or graphic can be embedded in the data track, without any masking image or text, to carry machine-readable code on the recorded CD. Or a pure or raw digital watermark signal can be burned into the data side of the CD, without being embedded in an image or text. The signal may appear like noise or randomly placed marks. More likely, however, the burned-in watermark signal will be generally imperceptible to human inspection. Each of the above marking techniques are detectable from an optically captured image of the data side of the disc 60, in the manner discussed above with respect to FIG. 4.

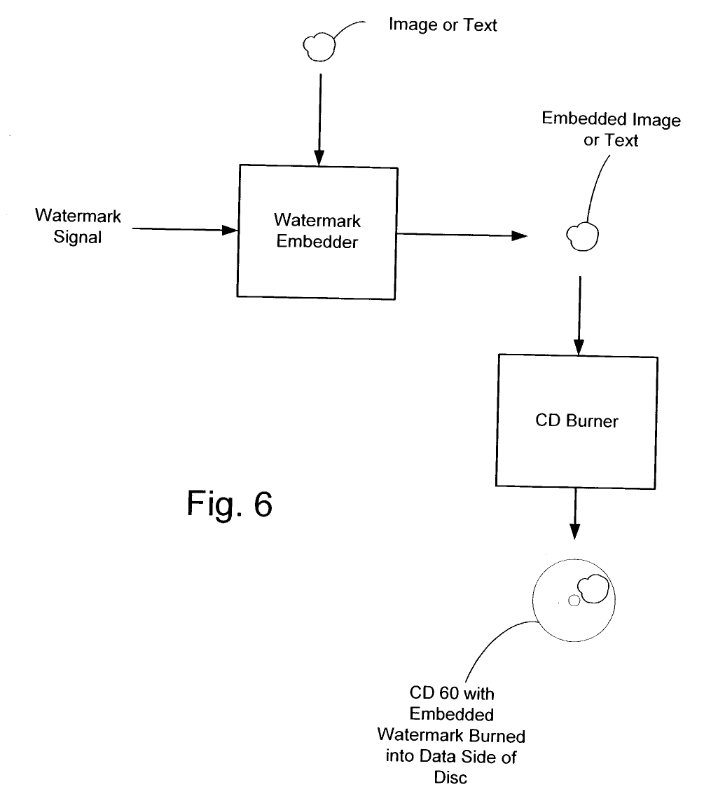

With reference to FIG. 6, a user selects an image or text message that is to be burned onto her CD. (In other embodiments, an image or text is automatically selected.). The text message may be a label for the disc, or may convey the play list (e.g., reflecting songs recorded on the disc). The image may be a graphic, logo, picture, symbol, number, etc., etc. A watermark embedder embeds a watermark signal in the image or text. Many of the above embedding techniques can be utilized for this image embedding.

In some cases, the image (e.g., 1-bit per pixel image) is altered to include a hidden message. In other embedding techniques a multi-bit per pixel image is embedded with a digital watermark, and then the embedded multi-bit per pixel image is converted to a 1-bit image. The embedded digital watermark preferably survives the conversion from a multi-bit per pixel image to a 1-bit per pixel image. Additional watermarking techniques are disclosed in the applications and patents incorporated above. Such embedding techniques maybe suitable interchanged with this aspect of the present invention. (In an implementation for watermarking text, the techniques disclosed in assignee's U.S. patent application Ser. No. 09/074,034, filed May 6, 1998 (Allowed) and Ser. No. 10/187,252, filed Jun. 28, 2002, titled “Watermark Fonts,” along with those disclosed in U.S. Pat. No. 6,086,706 may also be interchangeably used to convey a steganographic information signal.). Of course, there are may other image and text embedding techniques that may be suitable interchanged with this aspect of the present invention.

Returning to FIG. 6, the watermarked image (or text) is imparted to (e.g., burned into) the data side of a CD disc 60, e.g., via a CD burner. Of course, we recognize that the watermark embedder and CD burner can be incorporated into the same physical device. The watermark embedded within the image (or text) is detectable from an optically captured image of the data side of the embedded CD, e.g., as discussed with respect to FIGS. 3 and 4.

The linking (e.g., as discussed with reference to FIG. 5) and authentication aspects of the present invention are also applicable to CDs embedded via burning in of embedded images or text.

Concluding Remarks

The foregoing are just exemplary implementations of the present invention. It will be recognized that there are a great number of variations on these basic themes. The foregoing illustrates but a few applications of the detailed technology. There are many others.

To provide a comprehensive disclosure without unduly lengthening this specification, the above-mentioned patents and patent applications are hereby incorporated by reference. The particular combinations of elements and features in the above-detailed embodiments are exemplary only; the interchanging and substitution of these teachings with other teachings in this application and the incorporated-by-reference patents/applications are expressly contemplated.

In an alternative arrangement, CD 40 (FIG. 5) includes a visual design 10a (FIG. 3). A digital watermark, e.g., an imperceptible digital watermark formed through CD pit placement or deviation, is formed in a CD area outside of the visual design 10a. In still another arrangement, such a digital watermark is included in both a visual design 10a and an area outside of the visual design 10a.

The above-described methods and functionality can be facilitated with computer executable software stored on computer readable media. Such software may be stored and executed on a general-purpose computer, or on a server for distributed use. Also, instead of software, a hardware implementation, or a software-hardware implementation can be used.

In view of the wide variety of embodiments to which the principles and features discussed above can be applied, it should be apparent that the detailed embodiments are illustrative only and should not be taken as limiting the scope of the invention. Rather, I claim as my invention all such modifications as may come within the scope and spirit of the following claims and equivalents thereof.

What is claimed is:

1. An information hiding method comprising the steps of:
providing an information signal;
providing an image or text;
steganographically marking the image or text to convey the information signal; and
arranging data in a data side of physical media to convey the marked image or text, wherein the marking remains generally imperceptible to a human observer, while the image or text remains perceptible to the human observer.

2. The method according to claim 1, wherein information signal comprises a digital watermark component.

3. The method of claim 2, wherein the digital watermark is generally imperceptible in comparison to the image or text.

4. The method according to claim 1, wherein the physical media comprises one of at least a SACD, CD, CD-RW, DVD, laser disc, and mini-disc.

5. The method of claim 1, wherein the information signal comprises at least one of a payload and identifier.

6. The method according to claim 1, wherein the marking is detectable from an optically captured 2-dimensional image of the marked image or text.

7. The method according to claim 2, wherein the digital watermark is detectable from an optically captured 2-dimensional image of the marked image or text.

8. The method of claim 1, wherein said arranging step employs a CD burner.

9. The method of claim 8, wherein the CD burner comprises a CRW-F1 CD burner.

10. A method of linking a compact disc to related information, the compact disc comprising a steganographic watermark embedded in an image, wherein the embedded image is burned into a data side of the disc, and wherein the steganographic watermark comprises auxiliary data, said method being characterized by presenting the compact disc to a watermark detector; and when the watermark detector finds the watermark, linking to information related to the compact disc through the auxiliary data carried by the watermark.

11. The method of claim 10, wherein the image comprise text.

12. A method of marking physical media, the physical media comprising a data side including a first area to receive data, said method comprising:
providing an information signal; and
burning a visibly perceptible pattern in a second area of the data side of the physical media by selectively storing data to the second area of the media to form the visibly perceptible pattern, the visibly perceptible pattern conveying the information signal, wherein the first and second areas are separate areas, wherein the information signal is machine-detectable from an optically-captured image including the visibly perceptible pattern.

13. The method of claim 12, wherein pattern includes an image or text, and wherein the information signal is embedded in the image or text in the form of a digital watermark.

14. The method of claim 12, wherein the visibly perceptible pattern is included as a background pattern in the physical media.

15. The method of claim 12 wherein the visibly perceptible pattern comprises the information signal.
